(19) United States
(12) Patent Application Publication
(10) Pub. No.: US 2013/0221042 A1
(43) Pub. Date: Aug. 29, 2013

(54) RECEIVER MOUNTED SPARE TIRE CARRIER HITCH SYSTEM

(71) Applicant: William Olen Fortner, Gillette, WY (US)

(72) Inventor: William Olen Fortner, Gillette, WY (US)

(21) Appl. No.: 13/775,392

(22) Filed: Feb. 25, 2013

Related U.S. Application Data
(60) Provisional application No. 61/603,606, filed on Feb. 27, 2012.

(51) Int. Cl. B62D 43/02

(52) U.S. Cl. CPC B62D 43/02
USPC 224/42.21

(57) ABSTRACT

Spare tire carrying systems including a connection tube that may be installed in a receiver tube attached to a vehicle. At a distal end of the connection tube is disposed a receiver for connection to drop hitch end. Rotationally attached to the upper surface of the receiver is a pivotable arm. A lateral support may be disposed at the distal end of the pivotable arm and an attachment structure for connecting to the rim of a spare tire may be disposed on the lateral support or on the pivotable arm. The pivotable arm may be raised and lowered with respect to the receiver and the system and may be retained in the raised position for travel.

### CROSS-REFERENCE TO RELATED APPLICATION

This application claims the benefit of U.S. Provisional Application No. 61/603,606, filed Feb. 27, 2012, the disclosure of which is incorporated herein by reference in its entirety.

### TECHNICAL FIELD

The present disclosure relates to spare tire carriers.

### BACKGROUND

Most pickup trucks available on the market today come equipped with a standard spare tire carrier that is located underneath the vehicle. Thus, when faced with a flat tire, a user must retrieve the spare from under the vehicle. This can prove difficult where road (or off-road) conditions limit accessibility. Additionally, both the spare tire and the spare tire carrier are exposed to the environment during regular use of the vehicle, but are placed in a location that is not typically examined by a user during regular use. It is only upon trying to change a tire that a user may discover that the spare tire has been damaged by road debris and will not hold air, or that the carrier or a lock has been damaged by road debris or conditions and will not deploy to allow access to the spare tire.

Because of these issues, many users place the spare tire in the truck bed. However, this can take up cargo space that may be needed for other purposes, or make the spare tire at risk for theft.

Because of these difficulties, there have been a number of spare tire carriers designed that attempt to solve these problems by placing the tire near the rear of a vehicle, but not in the truck bed. Some examples include U.S. Pat. Nos. 1597639, 3387754, 3448904, 3507514, 3610658, 4410117, 4418851, 4483468, 4485345, 4717054, 4971237, 6918520, and 7861902. The disclosures of each of these references are incorporated herein in their entireties. However, many of these are attached to the bumper or frame of a vehicle, requiring a fairly permanent installation. Others may block the access to the bed of pickup or interfere with the path of the tailgate. Others that connect to a receiver of a receiver hitch are removable, but prevent the vehicle from being used for towing when attached.

A spare tire carrier that allowed for easy installation and removal and allowed for the use of the vehicle for towing when in place would be an improvement in the art.

### SUMMARY

The present disclosure includes a spare tire carrying system including a connection tube that may be installed in a receiver tube attached to a vehicle. At a distal end of the connection tube is disposed a receiver for connection to a drop hitch end. Rotationally attached to the upper surface of the receiver is a pivotable arm. A lateral support may be disposed at the distal end of the pivotable arm and an attachment structure for connecting to the rim of a spare tire may be disposed on the lateral support or on the pivotable arm, such as at the junction thereof. The pivotable arm may be raised and lowered with respect to the receiver and the system and may be retained in the raised position for travel.

### DESCRIPTION OF THE DRAWINGS

It will be appreciated by those of ordinary skill in the art that the various drawings are for illustrative purposes only. The nature of the present disclosure, as well as embodiments of systems and apparatus in accordance with the principles of the present disclosure, may be more clearly understood by reference to the following detailed description, to the appended claims, and to the several drawings.

FIGS. 1 and 2 are side and rear views of a spare tire carrier system in accordance with one aspect of the present disclosure.

FIGS. 3 and 3A are side perspective views of a rear portion of the system of FIGS. 1 and 2.

### DETAILED DESCRIPTION

The present disclosure relates to apparatus, systems and method for spare tire carrier systems and assemblies. It will be appreciated by those skilled in the art that the embodiments herein described, while illustrating certain embodiments, are not intended to so limit the scope of the appended claims. Those skilled in the art will also understand that various combinations or modifications of the embodiments presented herein can be made without departing from the scope of this disclosure. All such alternate embodiments are within the scope of the appended claims.

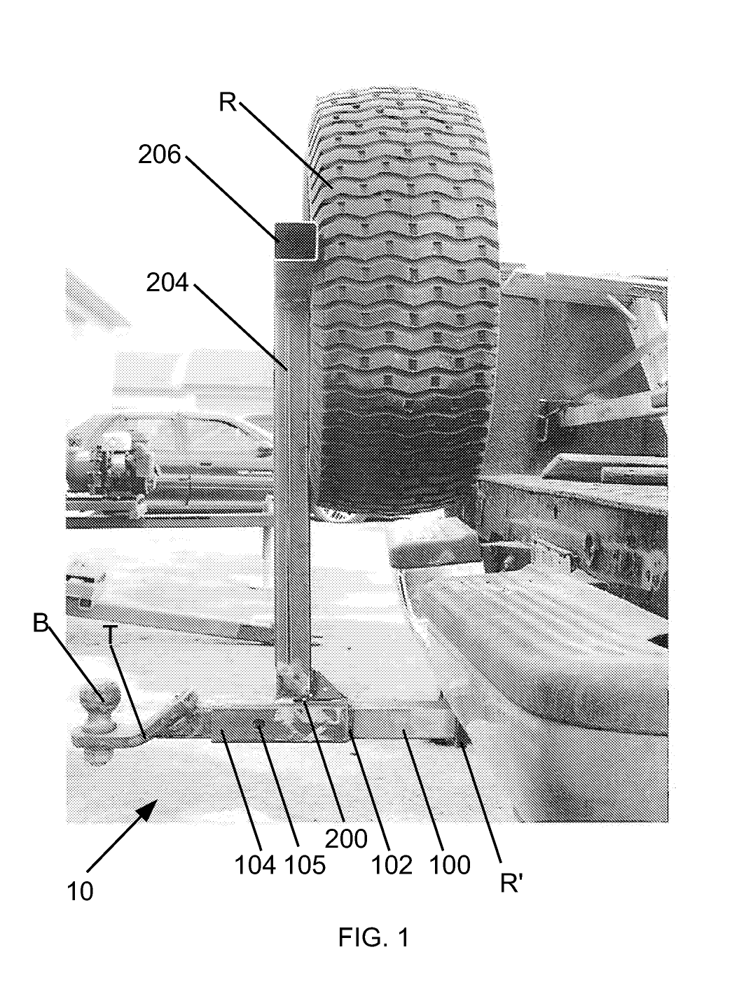

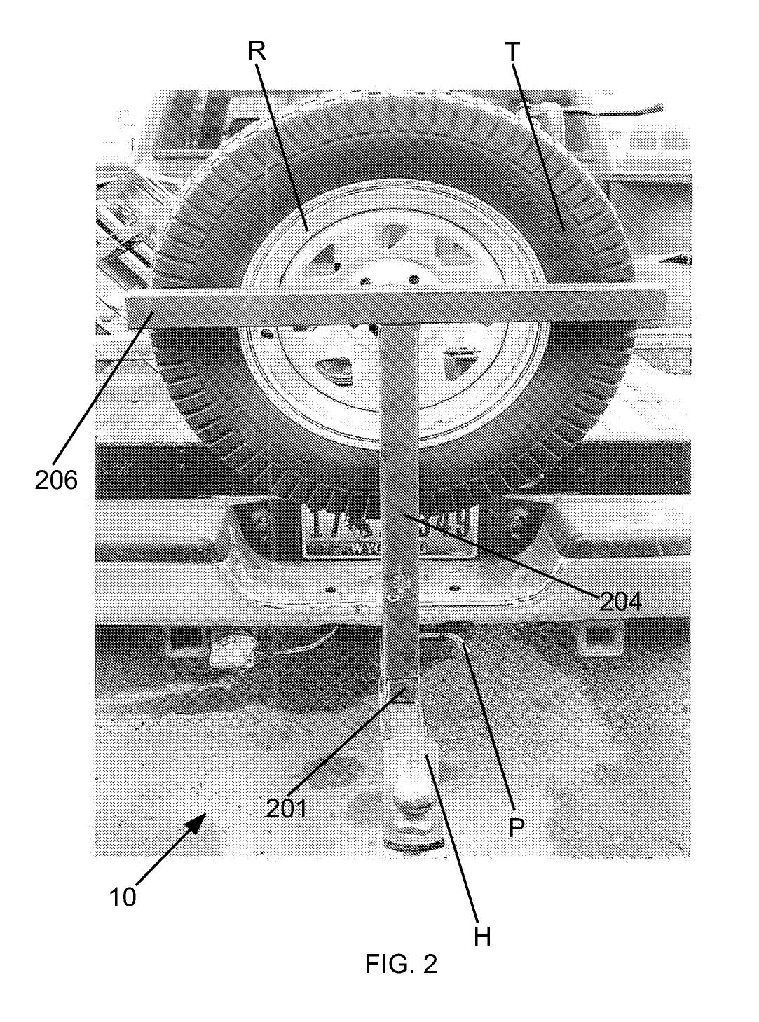

Referring to FIGS. 1 through 3A, one embodiment of a spare tire carrier system 10 in accordance with the principles of the present disclosure is depicted. Beginning at a proximal end thereof (in relation to the primary vehicle), there is depicted a connection tube 100 that may be installed in a receiver tube R′ attached to a vehicle. The connection tube 100 extends from a proximal end to a distal connection end 102. The connection tube 100 is sized and configured for slidable placement in a receiver tube R′ (FIG. 1) disposed at the rear of a primary vehicle. As depicted, the receiver tube R′ and connection tube 100 may have square cross-sectional shapes. The connection tube 100 may be a hollow tube or may be a solid bar, depending on the requirements of a particular system. One or more holes may pass laterally through the connection tube 100 allowing it to be secured in the receiver tube R′ by placement of a rod or pin P (FIG. 2) therethrough.

At distal end 102 of connection tube 100 is disposed a receiver 104 for connection to a drop hitch end H or other hitch end for connecting to a counterpart hitch for towing a trailer. As depicted, the receiver 104 may have a square cross-sectional shape. One or more holes 105 may extend laterally through the receiver 104 allowing a rod or pin to be inserted therethrough. As depicted, a drop hitch end H with a ball B or other connection structure may be mounted in receiver 104 and secured therein for towing. Thus, in use, a user may secure the connection tube 100 in receiver tube R′ on the primary vehicle, then secure the drop hitch end H in receiver 104 and use the vehicle for towing in the same manner as if drop hitch end H were directly installed in receiver tube R′.

It will be appreciated that although depicted as separate members that are welded together end-to-end, the connection tube 100 and receive 104 may be formed as an integrated structure.

Rotationally attached to the upper surface of the receiver 104 is a pivotable arm 204. The pivotable arm 204 may be rotationally attached by a hinge or pivot 200 disposed on the top surface of the receiver 104. As best depicted in FIG. 2, the hinge or pivot 200 may include a support block 201 that resides in a cutout in the lower (rear) surface of the pivotable arm 204, allowing rotation, while providing reinforcement and support to the arm and the connection.

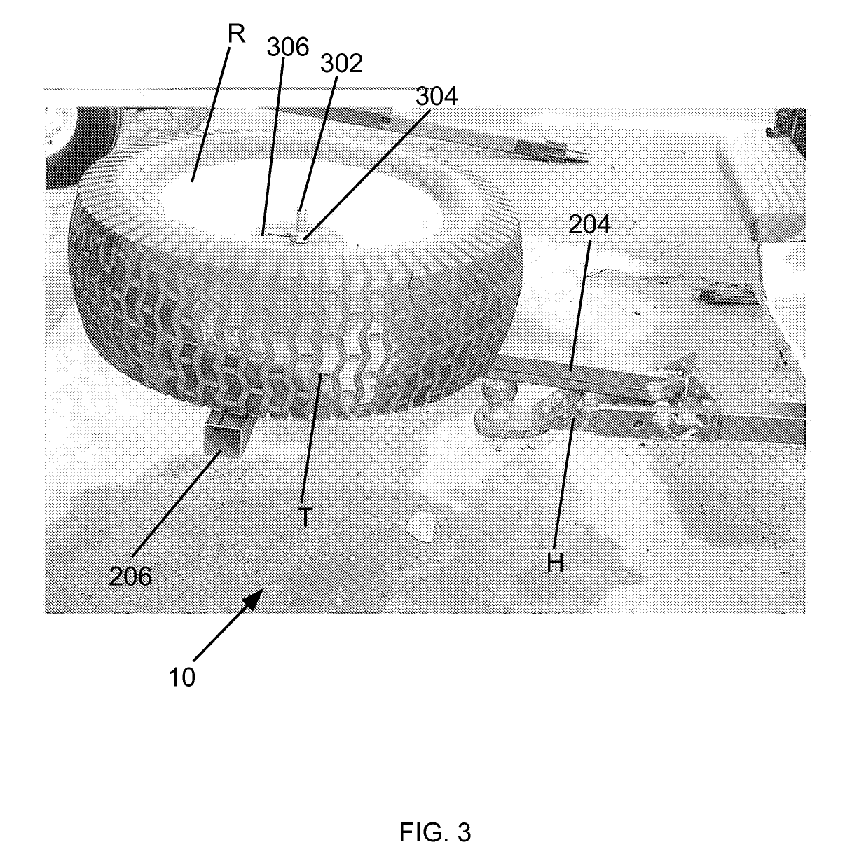

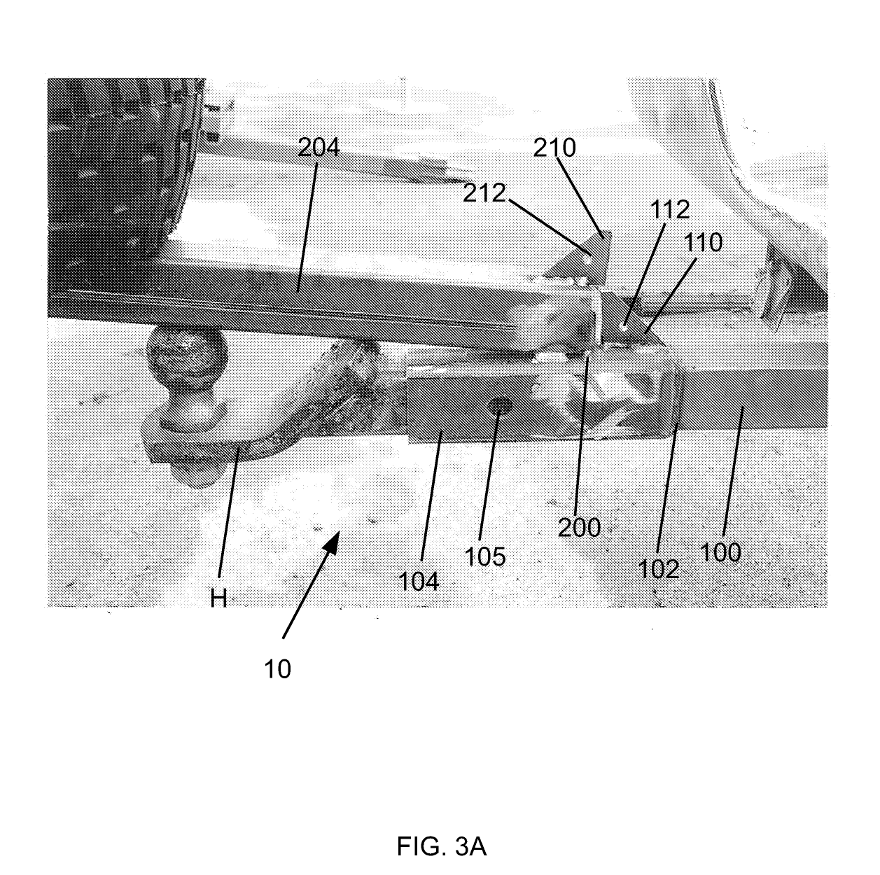

Pivotable arm 204 may be raised and lowered with respect to the receiver 104 by rotation at the hinge or pivot 200. The pivotable arm 204 may be retained in the raised position for travel. In the depicted embodiment, there is a flange 210 with a locking hole 212 (FIG. 3A) disposed therein on the top/front surface of the pivotable arm 204. Upon rotation to the upright position, the flange 210 aligns with one or more counterpart flanges 110 disposed on the receiver 104. In one illustrative embodiment, there may be two flanges 110 disposed on either side of flange 210. Locking holes 112 on the counterpart flanges align with locking hole 212 on flange 210 and a rod or pin may be inserted therethrough to retain the pivotable arm in the upright position. It will be appreciated that alternative structures known to those in the art that are capable of locking the pivotable arm 204 in a raised position may be used.

A lateral support 206 may be disposed at the distal end of the pivotable arm 204 and extend laterally to support a spare tire placed thereon. An attachment structure for connecting the system to the rim R of a spare tire T may be disposed on the lateral support or on the pivotable arm. When placed on the lateral support 206 the attachment structure may be aligned with the pivotable arm 204, and when placed on the pivotable arm 204 the attachment structure may be aligned with the lateral support 206. In some embodiments, the attachment structure may be placed at the junction of the pivotable arm 204 and the lateral support 206.

In the depicted embodiment, the attachment structure includes a threaded rod 302 extending from the lateral support 206 or pivotable arm 204. The rim R of a spare tire T may be placed on the lateral bar 206 or pivotable arm 204 with the threaded rod 302 extending through a central hole thereof. A retaining plate 306 is then placed on the rim, with the threaded rod 302 extending though a hole in the retaining plate 306. A securing nut, such as wingnut 304 is then threaded onto the rod 302 to secure retaining plate 306 in position and retain the spare tire T in place. In some embodiments, alignment structures or supporting plates may be placed on the lateral support 206 and/or the pivotable arm 204 so that the tire T and rim R interact therewith to assist in the alignment and retention.

For use, a user inserts the connection tube 100 into a receiver tube R on a primary vehicle and retains the connection tube 100 therein, as by inserting a rod or pin P. The pivotable arm 204 may be rotated down and a spare tire T secured in place. The pivotable 204 arm may then be rotated upwards and secured in the upright position for travel. Where desired, a drop hitch end H may be secured in receiver 104 and the primary vehicle used for towing.

While this document utilizes the depicted embodiments in setting forth this disclosure, such embodiments are only illustrative and the teachings can be further modified within the spirit and scope of this disclosure. This application is therefore intended to cover any variations, uses, or adaptations of the disclosure that use its general principles. Further, this application is intended to cover such departures from the present disclosure as come within known or customary practices in the art and which fall within the limits of the appended claims.

What is claimed is:

1. A spare tire carrying system comprising:
a connection arm that may be installed in a receiver tube attached to a vehicle;
a receiver for connection to a removable hitch end disposed at a distal end of the connection arm;
a pivotable arm rotationally attached to the upper surface of the receiver;
a lateral support disposed at a distal end of the pivotable arm; and
an attachment structure for connecting to the rim of a spare tire disposed on the lateral support.

2. The spare tire carrying system of claim 1, wherein the connection arm comprises a solid bar having a generally square cross sectional shape.

3. The spare tire carrying system of claim 1, wherein the connection arm includes one or more holes passing generally horizontally therethrough for connecting to the receiver tube by placement of a connection pin therein.

4. The spare tire carrying system of claim 1, wherein the receiver for connection to a removable hitch end comprises a receiver tube for receiving a drop end hitch.

5. The spare tire carrying system of claim 1, wherein the receiver is attached to the distal end of the connection arm by welding.

6. The spare tire carrying system of claim 1, wherein the pivotable arm is rotationally attached to the upper surface of the receiver by a hinge.

7. The spare tire carrying system of claim 6, wherein the hinge includes a support block which resides in a cutout in a lower surface of the pivotable arm, allowing rotation while providing support to the arm.

8. The spare tire carrying system of claim 1, wherein the pivotable arm may be locked in an upright position for travel.

9. The spare tire carrying system of claim 8, further comprising a flange disposed on the pivotable arm, such that the pivotable arm may be locked in an upright position for travel by securing the flange to a counterpart structure disposed on the receiver.

10. The spare tire carrying system of claim 9, wherein the counterpart disposed on the receiver comprises one or more counterpart flanges disposed on the receiver to which the flange may be secured.

11. The spare tire carrying system of claim 1, wherein the attachment structure on the lateral support comprises a threaded rod extending from the lateral support that can pass through a hole in a rim of a spare tire and a threaded retainer for securing the spare tire in place.

12. The spare tire carrying system of claim 1, wherein the attachment structure on the lateral support is aligned with the pivotable arm.

13. A spare tire carrying system comprising:
a lateral base member having a proximal end that may be installed in a receiver tube attached to a vehicle and a distal end which comprises a receiver for connection to a removable hitch end;
a pivotable arm rotationally attached to the upper surface of the lateral member; and
an attachment structure for connecting to the rim of a spare tire disposed on the pivotable arm.

14. The spare tire carrying system of claim 13, wherein the lateral base member has a generally square cross sectional shape.

15. The spare tire carrying system of claim 13, wherein the lateral base member includes one or more holes passing generally horizontally therethrough for connecting to the receiver tube by placement of a connection pin therein.

16. The spare tire carrying system of claim 13, wherein the receiver for connection to a removable hitch end comprises a receiver tube for receiving a drop end hitch.

17. The spare tire carrying system of claim 13, wherein the pivotable arm is rotationally attached to the upper surface of the lateral base member by a hinge.

18. The spare tire carrying system of claim 13, further comprising a flange disposed on the pivotable arm, such that the pivotable arm may be locked in an upright position for travel by securing the flange to one or more counterpart flanges disposed on the lateral base member.

19. The spare tire carrying system of claim 13, wherein the attachment structure on the pivotable arm comprises a threaded rod extending from the pivotable arm that can pass through a hole in a rim of a spare tire and a threaded retainer for securing the spare tire in place.

20. The spare tire carrying system of claim 13, further comprising a lateral support disposed at a distal end of the pivotable arm.

21. The spare tire carrying system of claim 20, wherein the attachment structure on the pivotable arm is aligned with the lateral support.
